(19) United States
(12) Patent Application Publication
(10) Pub. No.: US 2007/0177222 A1
(43) Pub. Date: Aug. 2, 2007

(54) Document disposal apparatus

(75) Inventors: Shunsuke Hamasuna, Kanagawa (JP); Ryuuichi Shiraishi, Kanagawa (JP); Kengo Shinozaki, Kanagawa (JP); Hiroyoshi Uejo, Kanagawa (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/519,803

(22) Filed: Sep. 13, 2006

(30) Foreign Application Priority Data
Jan. 31, 2006 (JP) 2006-022701

(51) Int. Cl. H04N 1/04

(52) U.S. Cl. 358/474; 358/304

(57) ABSTRACT

A document disposal apparatus is provided and includes: a disposal processing section that disposes of a document; a document placement section on which the document is placed; a reading section that reads identification information of the document, the identification information being attached to the document, and makes a judgment whether the document exists on the document placement section; and a controller that controls the disposal processing section in accordance with a reading result of the reading section.

### BACKGROUND

(i) Technical Field

The present invention relates to a document disposal apparatus, which is suitable for use in document management.

(ii) Background Art

In general, many secret documents that should be kept secret from outsiders (e.g., parties outside the company) are handled in offices of companies and public organizations such as city halls. To prevent leakage to third parties, the originals of such secret documents are kept in storage under strict management. On the other hand, secret documents that are no longer necessary are disposed of with a shredder or the like.

In many cases, compulsory storage periods are specified for secret documents relating to accounting (bills, receipts, statements of accounts, etc.). Therefore, when a secret document is disposed of by shredding, it is necessary to store a record of its disposal. It is also necessary for a person in charge to confirm, before the disposal, using a register of originals or the like, that disposal of the secret document he or she is going to dispose of is really appropriate.

However, in the case of disposing of a large number of secret documents, the work of disposing of the secret documents while storing respective disposal records the respective secret documents one by one and checking their respective storage periods one by one is very troublesome and takes long time.

### SUMMARY

According to an aspect of the present invention, there is provided a document disposal apparatus including: a disposal processing section that disposes of a document; a document placement section on which the document is placed; a reading section that reads identification information of the document, the identification information being attached to the document, and makes a judgment whether the document exists on the document placement section (that is, the reading section serves as a document detecting section); and a controller that controls the disposal processing section in accordance with a reading result of the reading section.

### BRIEF DESCRIPTION OF THE DRAWINGS

Embodiments of the present invention will be described in detail based on the following figures, wherein:

FIG. 1 is a block diagram showing a configuration of a document disposal apparatus according to an exemplary embodiment of the present invention;

FIG. 2 shows an exemplary configuration of a document disposal apparatus;

FIG. 3 shows another exemplary configuration of a document disposal apparatus;

FIG. 4 shows an exemplary configuration of a document management system in which a document disposal apparatus, a document generation apparatus, a document management apparatus are network-connected to one another;

FIG. 5 is a block diagram of an exemplary document generation apparatus;

FIG. 6 is a block diagram of an exemplary document management apparatus;

FIGS. 7A and 7B show exemplary documents in which identification information is recorded;

FIG. 8 shows an exemplary structure of data managed by a document management apparatus;

FIG. 9 is a flowchart of a first exemplary process which is executed by a document disposal apparatus; and

FIG. 10 is a flowchart of a second exemplary process which is executed by a document disposal apparatus.

### DETAILED DESCRIPTION

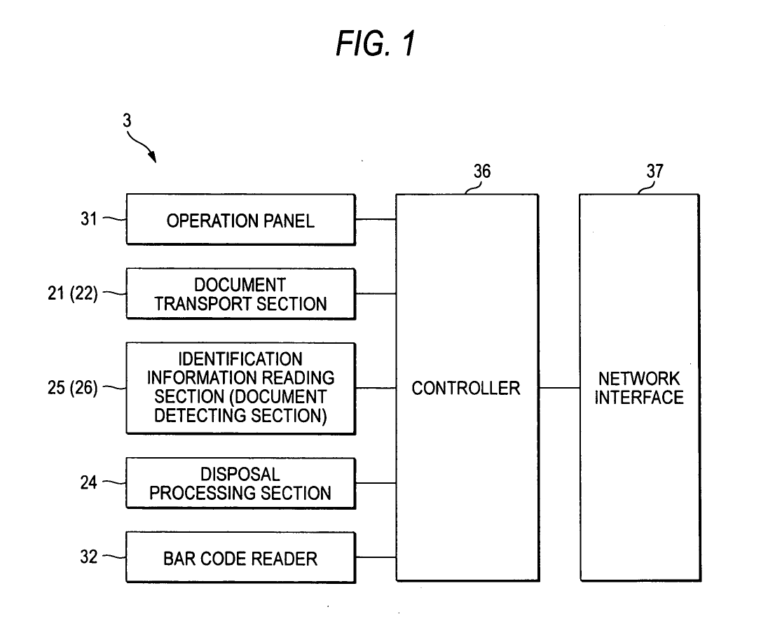

Exemplary embodiments of a document disposal apparatus according to one aspect of the present invention will be hereinafter described with reference to FIGS. 1 to 10.

FIG. 1 is a block diagram showing a configuration of a document disposal apparatus according to an exemplary embodiment of the invention. A document disposal apparatus 3 is equipped with an operation panel 31, document transport sections 21 and 22, an identification information reading sections 25 and 26 which also serves as document detecting sections, a disposal processing section 24, a bar code reader 32, a controller 36, and a network interface 37.

The operation panel 31 is manipulated by a user who uses the document disposal apparatus 3. For example, the operation panel 31 is configured by using manipulation buttons and a display panel which displays an operation status of the document disposal apparatus 3 and various messages including manipulation guidance messages.

The bar code reader 32 optically reads, using a reading optical system (described later), a bar code that is attached to a document by printing, and outputs original information (data) contained in the bar code provided in the document.

The controller 36 controls various operations relating to document disposal. The controller 36 controls operations of the document transport sections 21 and 22, the identification information reading sections (also serves as the document detecting sections) 25 and 26, the bar code reader 32, and the disposal processing section 24 according to control programs given in advance.

The network interface 37 is a communication interface via which the document disposal apparatus 3 exchanges data with other apparatus (including a document generation apparatus 1 and a document management apparatus 2 (described later)) over the network 4. Data exchange via the network interface 37 is controlled by the controller 36.

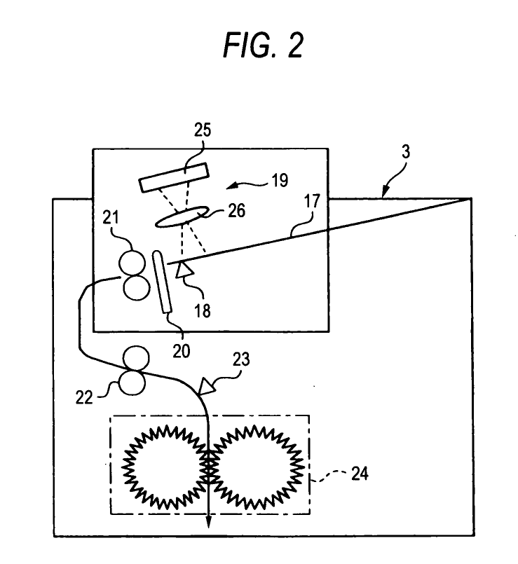

FIG. 2 shows an exemplary configuration of the document disposal apparatus 3. The document disposal apparatus 3, which is configured by using a shredder, for example, is equipped with a document tray 17, the document transport sections 21 and 22, an insertion sensor 18, a reading optical system 19 of the bar code reader 32, a stopper 20, a passage sensor 23, and the disposal processing section 24. The reading optical system 19 includes an area sensor 25 and a lens 26 which constitute the identification information reading section.

The document tray 17 is a unit on which a document as a subject of disposal is placed (i.e., a document placement section). The document tray 17 is inclined from the horizontal plane so as to descend gradually toward the stopper 20. The back side (lower side) of the document tray 17, together with the insertion sensor 18, the reading optical system 19, the stopper 20, and the document transport section 21, is covered with a cover member (not shown).

The insertion sensor 18 detects whether a document is placed on the document tray 17 and whether a document has been inserted to a reading position on the document tray 17. For example, the insertion sensor 18 is a reflection-type optical sensor having a light-emitting element and a photodetector. The insertion sensor 18 is rendered in an on-state when a document exists at its sensing position and in an off-state when no document exists at the sensing position.

The reading optical system 19 of the bar code reader 32 is configured in such a manner that light emitted from a light source (not shown) is applied to a bar code recording portion of a document as a subject of disposal and the area sensor 25 captures a bar code image by detecting reflection light via the lens 26 which is part of the identification information reading section. In this example, it is assumed that identification information that is attached to a document is information contained in a bar code. The bar code recording portion is a portion of a document surface where a bar code is recorded which includes a document ID and other information. The bar code recording portion is located at a corner position of a document and its dimensions are predetermined.

The stopper 20 has a long plate-like structure, for example, and is disposed between the insertion sensor 18 and the document transport section 21. The stopper 20 opens or closes a document transport passage formed by the document transport sections 21 and 22 at its entrance. In a closed state, the stopper 20 is projected so as to interrupt a document path from the document 17 to the document transport section 21. Therefore, in this state, if a user tries to insert a document inward on the document 17, the head of the document butts against the stopper 20. In contrast, in an open state, the stopper 20 is retracted from the document path from the document tray 17 to the document transport section 21. Therefore, if a user tries to insert a document inward on the document tray 17, the head of the document butts into the nip portion of the document transport section 21.

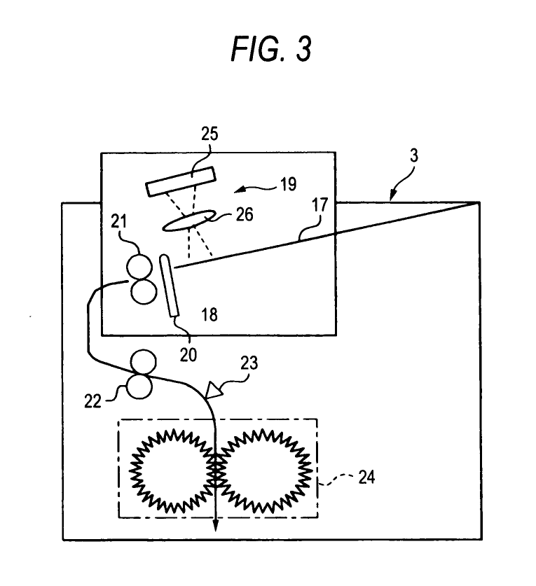

FIG. 3 shows another exemplary configuration of the document disposal apparatus 3 according to the embodiment. This document disposal apparatus 3 is not equipped with the insertion sensor 18 which is independently provided in the document disposal apparatus 3 of FIG. 2, because the identification information reading sections 25 and 26 also serves as the document detecting sections (i.e., sections each for detecting whether a document is placed on the document tray 17). The other part of the configuration of this document disposal apparatus 3 is the same as the corresponding part of the configuration of the document disposal apparatus 3 of FIG. 2, and hence will not be described in detail.

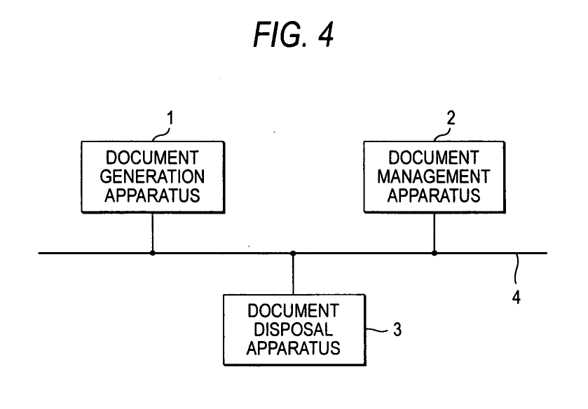

FIG. 4 shows an exemplary configuration of a document management system which includes a document generation apparatus 1, a document management apparatus 2, and a document disposal apparatus 3, which are network-connected to one another, that is, connected to a common network 4. The document generation apparatus 1 generates a document (e.g., paper document) to which a document ID (i.e., identification information of the document) is attached. The document management apparatus 2 performs various kinds of management processing on documents generated by the document generation apparatus 1. The document disposal apparatus 3 performs disposal processing on documents generated by the document generation apparatus 1 and other documents. The network 4 is configured by using a LAN (local area network) or a WAN (wide area network), for example.

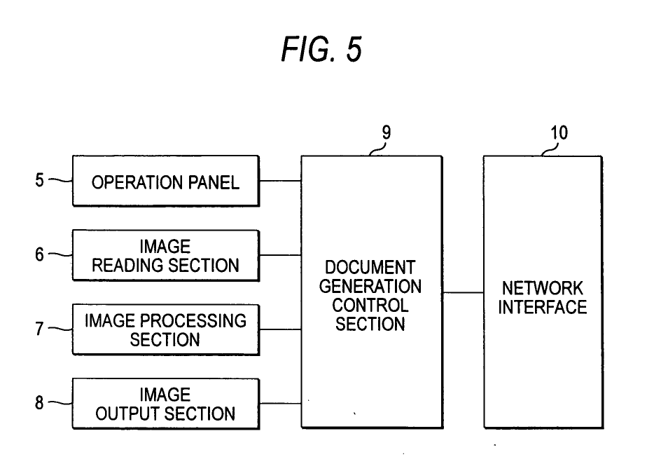

FIG. 5 is a block diagram showing an exemplary document generation apparatus 1. The document generation apparatus 1 is configured by using a digital copier, a digital multi-function machine (copier), or the like. The document generation apparatus 1 includes an operation panel 5, an image reading section 6, an image processing section 7, an image output section 8, a document generation control section 9, and a network interface 10.

The operation panel 5 serves as a user interface through which a user of the document generation apparatus 1 inputs various kinds of information and on which various kinds of information are displayed for the user. For example, the operation panel 5 includes an input unit having various buttons, switches, keys, etc. and a display unit which is a liquid crystal panel with a touch panel.

The image reading section 6 optically reads images of a document as a subject of reading. The image reading section 6 generates image data (scanning data) corresponding to a document sheet image by applying light to the surface of a document sheet set on a transparent document table (platen glass) and forming an image of reflection light returning from the document sheet surface on the photodetecting surface of a reading sensor (CCD sensor or the like) via an image forming optical system including mirrors and lenses. During that course, the document sheet surface is scanned for reading as the image forming optical system is moved.

The image processing section 7 performs an image processing (e.g., color conversion, color correction, gradation correction, enlargement/reduction, image rotation, and screen generation) on the image data produced by reading the document with the image reading section 6.

The image output section 8 prints the image data produced by the reading by the image reading section 6 and subjected to the image processing by the image processing section 7 on sheets or the like. The image output section 8 prints the image data by an electrophotographic method, for example.

The document generation control section 9 controls various operations relating to document generation. The document generation control section 9 controls operations of the operation panel 5, the image reading section 6, the image processing section 7, and the image output section 8 according to control programs given in advance.

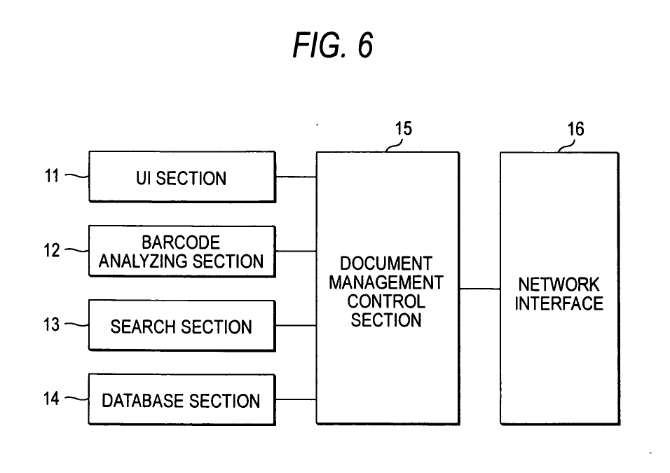

FIG. 6 is a block diagram showing an exemplary document management apparatus 2. The document management apparatus 2 is configured by using a personal computer, for example. The document management apparatus 2 includes a user interface section (UI section) 11, a bar code analyzing section 12, a search section 13, a database section 14, a document management control section 15, and a network interface 16.

The user interface section 11 is a user interface through which a user of the document management apparatus 2 inputs various kinds of information and on which various kinds of information are displayed for the user. For example, the user interface section 11 includes input devices such as a keyboard and a mouse and a display device such as a liquid crystal display.

The bar code analyzing section 12 analyzes and decodes a bar code that is contained in image data (scanning data). A bar code to be analyzed by the bar code analyzing section 12 is one that is contained in image data obtained when images of a document with a bar code are read by the document generation apparatus 1. This bar code is information including at least a document ID. In general, bar codes are generally classified into one-dimensional bar codes in which pieces of information are arranged only in one direction and two-dimensional bar codes in which pieces of information are arranged in two orthogonal directions. Bar codes of both types can be used in practicing the invention. However, where it is desired to have a bar code contain not only a document ID but also other various kinds of information and data, it is desirable to use a two-dimensional bar code having a larger data capacity. This embodiment employs, as an example, a QR code (registered trademark) which is a kind of two-dimensional bar code and is now widespread.

The search section 13 searches data accumulated in the database section 14. The database section 14 accumulates various kinds of data. For example, the database section 14 is configured by using a hard disk drive.

The document management control section 15 controls various operations relating to document management. The document management control section 15 controls operations of the user interface section 11, the bar code analyzing section 12, the search section, and the database section 14 according to control programs given in advance.

The network interface 16 is a communication interface via which the document management apparatus 2 exchanges data with other apparatus (including the document generation apparatus 1 and the document disposal apparatus 3) over the network 4. Data exchange via the network interface 16 is controlled by the document management control section 15.

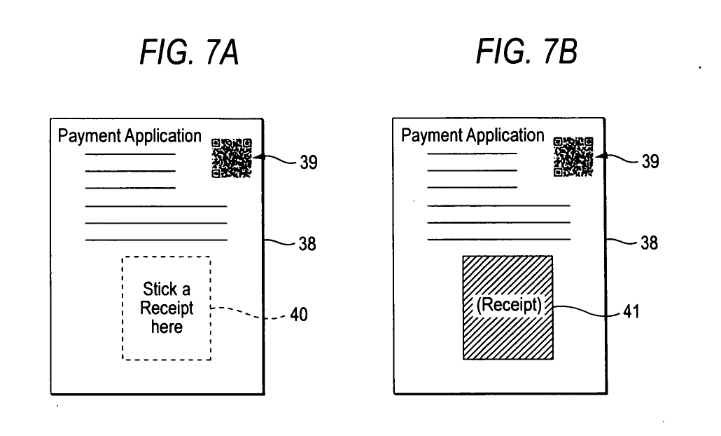

FIGS. 7A and 7B show exemplary documents in which identification information is recorded. An exemplary document management method using the above-configured document management system will be described below. Documents are generated by the document generation apparatus 1 while being assigned unique document IDs individually. The document ID may include only numerals or may be formed by combining numerals, alphabetical characters, symbols, etc. as appropriate. A specific management method that is directed to a case of handling documents to serve as vouchers for an accounting audit, a tax audit, etc. will be described below.

First, for example, a form of a payment application document 38 as shown in FIG. 7A is generated by inputting document data (electronic data) with a bar code to serve as a document template to the document generation apparatus 1 and printing the document data on a sheet with the image output section 8. For example, the document data may be generated by the document management apparatus 2 and sent from the document management apparatus 2 to the document generation apparatus 1 over the network 4. Alternatively, the document data may be generated separately by a server apparatus for document data generation and sent from the server apparatus to the document generation apparatus 1 over the network 4.

A QR code 39 which contains a document ID to be assigned to a payment application document 38 and other information is thereby attached, by printing, at a corner position, to the form of a payment application document 38 generated by the document generation apparatus 1. That is, a payment application document 38 to be generated by the document generation apparatus 1 corresponds to a “document to which a document ID is attached.” The form of a payment application document 38 has a region 40 to which a receipt is to be stuck. As shown in FIG. 7B, an applicant generates an original of a payment application document 38 by sticking a receipt 41 to the form of a payment application document 38 and, if necessary, adding statements and putting his or her seal thereto.

After generating the payment application document 38 in the above manner, the applicant sets it on the document table of the document generation apparatus 1 and causes the image reading section 6 to read its image. Alternatively, the generated information is sent from the document generation apparatus 1 to the document management apparatus 2 over the network 4 and registered as data. The image data that have been produced by reading the payment application document 38 with the image reading section 6 are sent to the document management apparatus 2 over the network 4. The original of the payment application document 38 that has been read is filed, for example, and put in storage.

Receiving the image data (scanning data) of the payment application document 38 from the document generation apparatus 1, the document management apparatus 2 stores the image data in the database section 14 and acquires decoded information of the document ID assigned to the payment application document 38 by analyzing the QR code image contained in the received image data with the bar code analyzing section 12. The document management control section 15 registers the thus-acquired document ID in a document management table, which is stored in the database section 14.

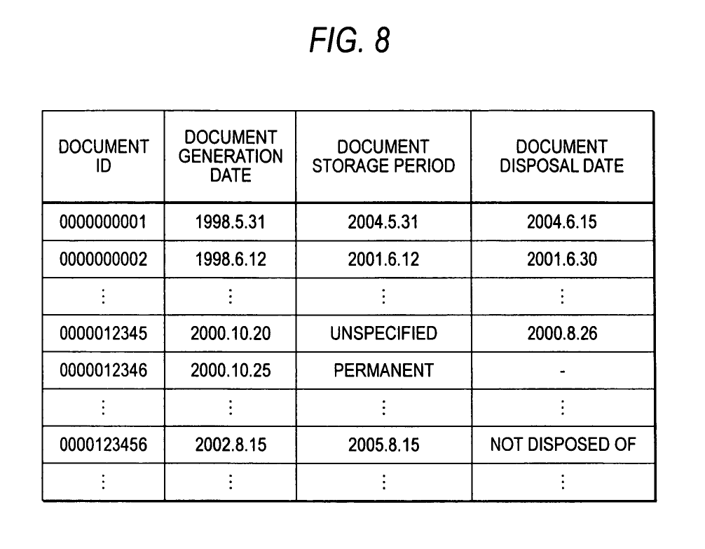

FIG. 8 shows an exemplary document management table that is managed by the document management apparatus 2. As shown in FIG. 8, a “document ID,” a “document generation date,” a “document storage period,” and a “document disposal date” are registered in the document management table so as to be correlated with one another. The “document ID” may be one obtained by decoding a QR code with the bar code analyzing section 12 or one that was assigned to the document by the document management apparatus 2 itself or a separate server apparatus when it generated document data with a bar code (mentioned above). The “document generation date” is a date of generation of the document. In this embodiment, a date on which image data produced by reading the document such as the payment application document 38 with the document generation apparatus 1 are sent to the document management apparatus 2 is registered as a “document generation date.”

The “document storage period” is the last date of a period in which the document should be kept in storage. Each document whose document ID is registered in the document management table should be kept in storage until the document storage period expires. If the “document storage period” registered is “unspecified,” the document can be disposed of anytime. If the “document storage period” registered is “permanent,” disposal of the document is always prohibited.

For example, if information for setting of a “document storage period” is contained, in addition to the document ID, in the QR code that is printed on the form of a payment application document 38, a “document storage period” can be set automatically on the basis of decoded information that is produced by the bar code analyzing section 12. More specifically, if information to the effect that the document storage period of the payment application document 38 should be set at 6 years is contained in the QR code, a date that is 6 years after the date of generation of the payment application document 38 can be set automatically as a “document storage period.”

In general, as for receipts, the storage period is determined in accordance with the amount of money received. Therefore, if information indicating the amount of money received of a receipt to be stuck to the form of a payment application document 38 is contained in the QR code, a storage period of the receipt can be determined automatically from that information and registered as a “document storage period” in the document management table. Furthermore, a user can manually change or set a “document storage period” registered or to be registered in the document management table using the user interface section II of the document management apparatus 2.

The “document disposal date” is a date when the document was disposed of. Documents are disposed of by the document disposal apparatus 3. Therefore, a date when a notice of completion of disposal of a document (hereinafter also referred to as “disposal completion notice”) is sent from the document disposal apparatus 3 to the document management apparatus 2 with designation of a document ID of a document that has been disposed of is registered in the document management table as a “document disposal date.”

Each of the “document generation date,” “document storage period,” and “document disposal date” among the registration items of the document management table may be registered in the form of a date and time. It is preferable that a user ID of a user who has generated a document using the document generation apparatus 1 be registered in the document management table as information indicating a document generator or that a user ID of a user who has disposed of a document using the document disposal apparatus 3 be registered in the document management table as information indicating a document disposer. In such a case, ID information of the user who has generated or disposed of the document can be acquired by utilizing an existing user authentication technique (e.g., one using an IC card).

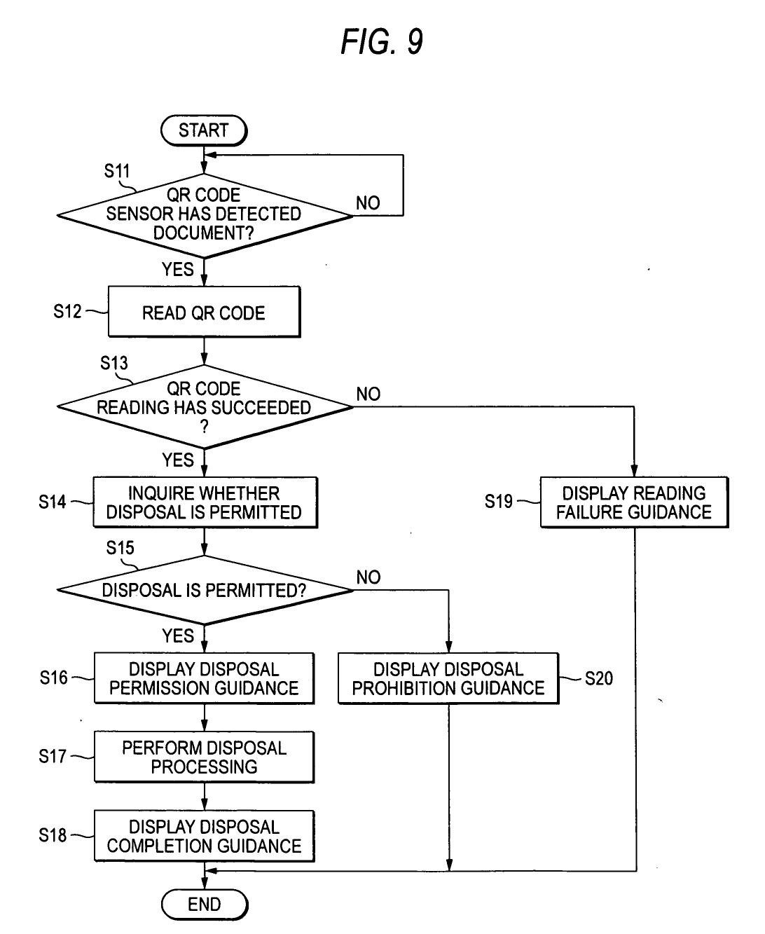

FIG. 9 is a flowchart of a first exemplary process which is executed by the document disposal apparatus 3. First, a user places a document as a subject of disposal on the document tray unit 17 of the document disposal apparatus 3. At this time, the controller 36 of the document disposal apparatus 3 is monitoring the state of the QR code sensor (step S11). Detecting (or judging) of the presence of the document is performed by reading QR code reading (step S12). The QR code sensor is the area sensor 25 which is part of the identification information reading section. If the output value of the QR code sensor has varied by more than a variation width, it is determined that a document exists on the document tray 17 (step S11: yes) and moves to step S12.

At step S13, the controller 36 of the document disposal apparatus 3 judges whether the identification information reading sections 25 and 26 has succeeded in reading the QR code. If the reading of the QR code has succeeded (step S13: yes), at step S14 the controller 36 inquires of, with designation of a document ID contained in the QR code, the document management apparatus 2 whether disposal of the document identified by the document ID is permitted.

Receiving a reply to the above inquiry, at step S15 the controller 36 judges whether the reply is to permit disposal of the document. If the reply is to permit disposal of the document, the controller 36 displays, at step S16, a guidance to the effect that disposal permission has been obtained, disposes of the document at step S 17, and displays, at step S 18, a guidance to the effect that the document has been disposed of. An exemplary guidance to be displayed when disposal of a document is permitted is “Disposal of this document is permitted, and hence the document will be transported automatically and disposed of.”

On the other hand, if the reading of the QR code has resulted in a failure (step S13: no), at step S19 the controller 36 displays a reading failure message which was prepared in advance. An exemplary reading failure guidance is “A code reading error has occurred. This document will be ejected without being disposed of.” If document disposal permission is not obtained (step S15: no), at step S20 the controller 36 displays a disposal prohibition guidance which was prepared in advance. An exemplary disposal prohibition guidance is “Disposal of this document is prohibited. This document will be ejected without being processed.”

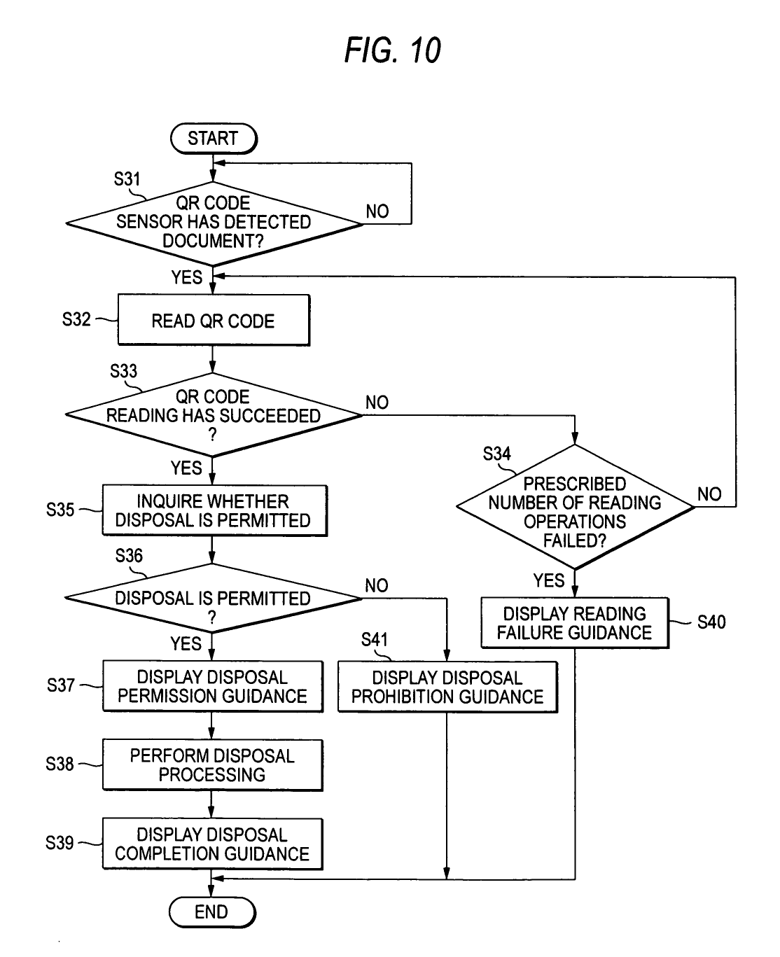

FIG. 10 is a flowchart of a second exemplary process which is executed by a document disposal apparatus 3. First, a user places a document as a subject of disposal on the document tray unit 17 of the document disposal apparatus 3. At this time, the controller 36 of the document disposal apparatus 3 is monitoring the state of the QR code sensor (step S31). Detecting (or judging) the presence of the document is performed by reading QR code (step S32). In this embodiment, the QR sensor performs detecting operations at intervals (intermittent operations). Upon detection of presence of the document, the reading mode of the QR code sensor is switched from the intermittent mode to a continuous mode in which a continuous operation of the reading is performed. The QR code sensor is the area sensor 25 which is part of the identification information reading section. If the output value of the QR code sensor has varied by more than a prescribed variation width, the controller 36 judges that a document exists on the document tray unit 17 (step S31: yes) and moves to step S32.

At step S33, the controller 36 of the document disposal apparatus 3 judges whether the identification information reading sections 25 and 26 has succeeded in reading the QR code. If the reading of the QR code has succeeded (step S33: yes), at step S35 the controller 36 inquires of, with designation of a document ID contained in the QR code, the document management apparatus 2 whether disposal of the document identified by the document ID is permitted.

Receiving a reply to the above inquiry, at step S36 the controller 36 judges whether the reply is to permit disposal of the document. If the reply is to permit disposal of the document, the controller 36 displays, at step S36, a guidance to the effect that disposal permission has been obtained, disposes of the document at step S38, and displays, at step S39, a guidance to the effect that the document has been disposed of. An exemplary guidance to be displayed when disposal of a document is permitted is “Disposal of this document is permitted, and hence the document will be transported automatically and disposed of.”

On the other hand, if the reading of the QR code has resulted in a failure (step S33: no), a QR code reading operation is performed again. This is to provide against a case that, in particular, a first QR code reading operation is performed with insufficient accuracy (the QR code reading sensor performs intermittent operations for detecting whether a document is present). If the QR code is not read successfully even if a prescribed number of QR code reading operations are performed, the controller 36 judges that the reading has failed (step S34: no) and displays, at step S40, a reading failure message which was prepared in advance. An exemplary reading failure guidance is “A code reading error has occurred. This document will be ejected without being disposed of.” If document disposal permission is not obtained (step S36: no), at step S41 the controller 36 displays a disposal prohibition guidance which was prepared in advance. An exemplary disposal prohibition guidance is “Disposal of this document is prohibited. This document will be ejected without being processed.”

What is claimed is:

1. A document disposal apparatus comprising:
a disposal processing section that disposes of a document;
a document placement section on which the document is placed;
a reading section that reads identification information of the document, the identification information being attached to the document, and makes a judgment whether the document exists on the document placement section; and
a controller that controls the disposal processing section in accordance with a reading result of the reading section.

2. The document disposal apparatus according to claim 1, wherein when the reading section can read identification information of the document, the reading section judges that a document exists on the document placement section.

3. The document disposal apparatus according to claim 2, wherein the reading section performs intermittent operations of reading the identification information.

4. The document disposal apparatus according to claim 3, wherein after the reading section judges that the document exists on the document placement section, the reading section performs a continuous operation of the reading the identification information.
